(19) United States
(12) Patent Application Publication
(10) Pub. No.: US 2014/0240983 A1
(43) Pub. Date: Aug. 28, 2014

(54) LED STREET LAMP

(71) Applicant: HERGY LIGHTING TECHNOLOGY CORP., Taipei City (TW)

(72) Inventors: Chun-Hung LU, Taipei City (TW); Chih-Hsin CHEN, Taipei City (TW)

(73) Assignee: HERGY LIGHTING TECHNOLOGY CORP., Taipei City (TW)

(21) Appl. No.: 13/777,447

(22) Filed: Feb. 26, 2013

(51) Int. Cl. F21V 29/00

(52) U.S. Cl. CPC F21V 29/2206
USPC 362/249.02

(57) ABSTRACT

An LED street structures includes a pair of frames, a plurality of LED modules, an electrical box, a side cover and a back cover. Each frame has a cover plate, a supporting plate and a blocking plate. The LED modules are arranged between the frames. Two sides of the LED modules are fixed on the supporting plate. The electrical box disposed by a lateral side of the LED modules covers one side of the frames. The side cover covers another side of the frames. The back cover positioned between the frames covers the LED modules.

### BACKGROUND OF THE INVENTION

1. Field of the Invention

The present invention generally relates to illumination devices, and more particularly to an LED street lamp.

2. Description of Related Art

Traditional street lightings are usually mercury lamps. Because the high heat resulting from long use always makes their service life limited, high power consuming, and environmental pollution, they tend to be replaced by a light emitting diode (LED) illumination device for advantages of high intensity, power saving and long service life, etc.

LEDs have a shortage of low light emitting efficiency and low power, a plurality of LEDs are grouped together and mounted on a circuit board as an LED light source for achieving demands of a wide range of irradiation and high-brightness. In this way, an outdoor illumination device can be accomplished with sufficient illumination. However, when few LEDs do not work, the entire LED illumination device has to be replaced or repaired for that a single LED cannot be replaced. Therefore, the maintenance of the LED illumination device is time-consuming, and the maintenance cost is high.

### SUMMARY OF THE INVENTION

Accordingly, an object of the present invention is to provide an LED street lamp, in which LED modules are installed and could be disassembled individually. Therefore, if any LED module is out of work, it can be disassembled and displaced by maintenance personnel. In this way, a better and simpler maintenance will be achieved. Thus, the time and cost of maintenance will be reduced.

Another object of the present invention is to provide an LED street lamp, in which the quantity of LED modules can be adjusted as demands without the circuit reconfigured.

In order to achieve the objects mentioned above, the present invention provides an LED street lamp including a pair of frames, a plurality of LED modules, an electrical box, a side cover and a back cover. The frames are disposed in symmetry. Each frame has a cover plate, a supporting plate and a blocking plate. The supporting plate and the blocking plate located on opposite sides of the cover plate are bent and extended from sides of the cover plate. LED modules are arranged between the pair of the frames in parallel and at interval. Two sides of each LED module are fixed on the supporting plates of the frames. Each of the LED modules includes a circuit board, a plurality of LEDs disposed on the circuit board and a heat dissipating fins assembly. The LED module has a back face and a light emitting face. The electrical box disposed by a lateral side of the LED modules covers one side of the frames. The side cover covers another side of the frames, and the back cover covers on back faces of the LED modules and positioning between the pair of frames.

Comparing to the related art, the LED street lamp of the present invention has the following effects. Because the LED modules of the LED street lamp can be disassembled individually, when any one of the LED modules out of work, the single LED module can be disassembled and displaced by maintenance personnel. In this way, the time and the cost of maintenance will be reduced. Furthermore, the quantity of the LED modules can be adjusted as demands, and the length of the frames can be adjusted correspondingly to meet the illumination and scope requirements.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective view of LED street lamp according to the present invention;

FIG. 2 is a perspective exploding view of LED light source and electrical box of the present invention;

FIG. 3 is a perspective exploding view of LED light source of the present invention;

FIG. 4 is another perspective view of LED street lamp of the present invention;

FIG. 5 is an assembled cross sectional view of the present invention;

FIG. 6 shows a second embodiment of the present invention;

FIG. 7 shows a third embodiment of the present invention;

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

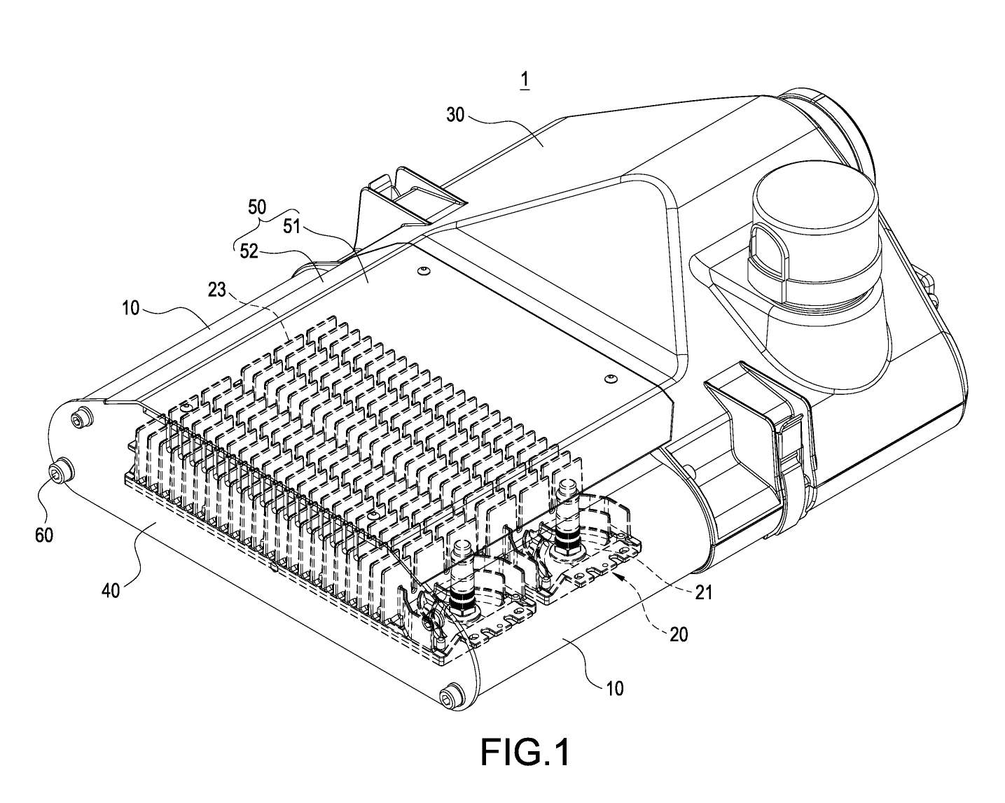

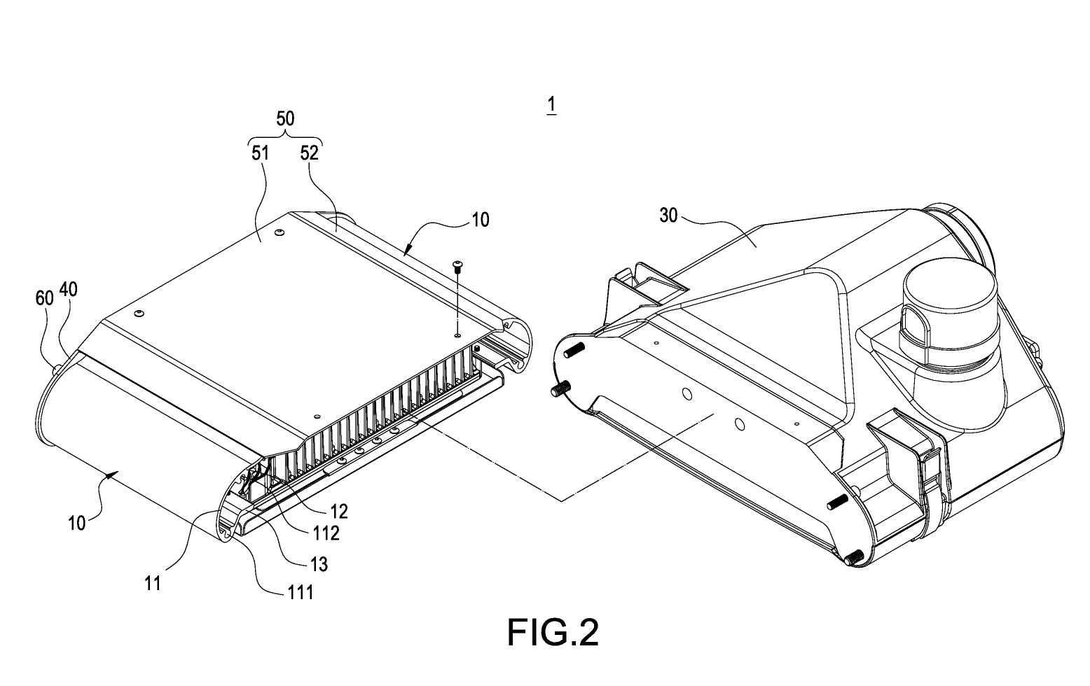

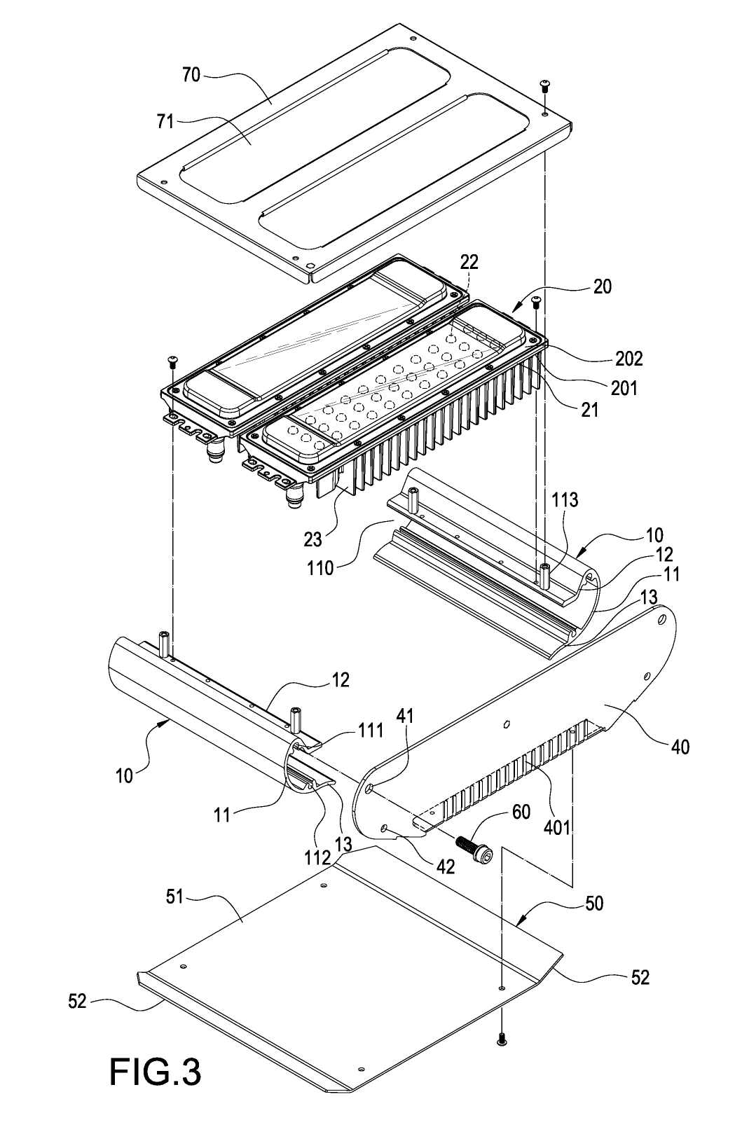

Please refer to FIG. 1 to FIG. 3, they depict a perspective view of LED street lamp, a perspective exploding view of LED light source and electrical box, and a perspective exploding view of LED light source. An LED street lamp 1 of the present invention includes a pair of frames 10, a plurality of LED modules 20, an electrical box 30, a side cover 40 and a back cover 50. An LED light source of the present invention includes a pair of frames 10, a plurality of LED modules 20, the side cover 40 and the back cover 50. The electrical box 30 is separately disposed on a lateral side of the LED light source.

The pair of frames 10 are disposed in symmetry. Each of the frames 10 has a cover plate 11, a supporting plate 12 and a blocking plate 13. The supporting plate 12 and the blocking plate 13 located on opposite sides of the cover plate 11 are bent and extended from sides of the cover plate. In a preferred embodiment, the cover plate 11 is a curved sheet. The supporting plate is bent form one side of the curved sheet and extended in a horizontal direction. An opening 110 is formed between the supporting plate 12 and the blocking plate 13.

The LED modules 20 are arranged between the pair of the frames 10 in parallel and at interval. Two sides of each LED module 20 are fixed on the supporting plates 12 of the frames 10 correspondingly. The LED module 20 has a back face 201 without light emission and a light emitting face 202. In an embodiment of the present invention, each of the LED modules 20 includes a circuit board 21, a plurality of LEDs 22 disposed on the circuit board 21 and a heat dissipating fins assembly 23. The heat dissipating fins assembly 23 is disposed on the back face 201 of the LED module 20.

In an embodiment of the present invention, the LED street lamp 1 has two set of LED module. In actual practice, the quantity of the LED modules 20 can be adjusted by demands, and the length of the frames 10 will be adjusted with the LED modules 20.

The electrical box 30 covering one side of the frames 10 is disposed by a lateral side of the frames 10. The side cover 40 covers another side of the frames 10. Besides, the side cover 40 has a plurality of heat dissipating holes 401. Heat resulted from the LED module 20 will dissipate from those heat dissipating holes 401 to the outside.

In an embodiment of the present invention, the LED street lamp 1 further comprises a plurality of fasten components 60. The cover plate 11 has a first combination hole 111 at the location where the cover plate 11 joins with the supporting plate 12 and a second combination hole 112 at the location where the cover plate 11 joins with the blocking plate 13. The side cover 40 has a first fixing hole 41 and a second fixing hole 42 correspond to the first combination hole 111 and the second combination hole 112 respectively. The fasten components 60 pass through the first combination hole 111 and the first fixing hole 41, the second combination hole 112 and the second fixing hole 42 for combining the side cover 40 to a side of the frames 10.

Moreover, the back cover 50 positioned between the pair of frames 10 covers on the back faces 201 of the LED modules 20. In an embodiment, the back cover 50 includes a bottom plate 51 and a pair of side wings 52 extending from opposite sides of the bottom plate 51. One side of the bottom plate 51 is fixed on the bottom edge of the side cover 40, and another side is fixed on the electrical box 30.

In an embodiment of the present invention, the LED street lamp 1 further comprises a decoration plate 70. The decoration plate 70 covers the light emitting faces 202 of the LED modules 20. The decoration plate 70 has a plurality of apertures 71 disposed at interval with a quantity corresponding to an amount of the LED modules 20. A way of assembling the decoration plate 70 is to provide a plurality of screw bolts 113 on each supporting plate 12 then screw the decoration plate 70 on the screw bolts 113.

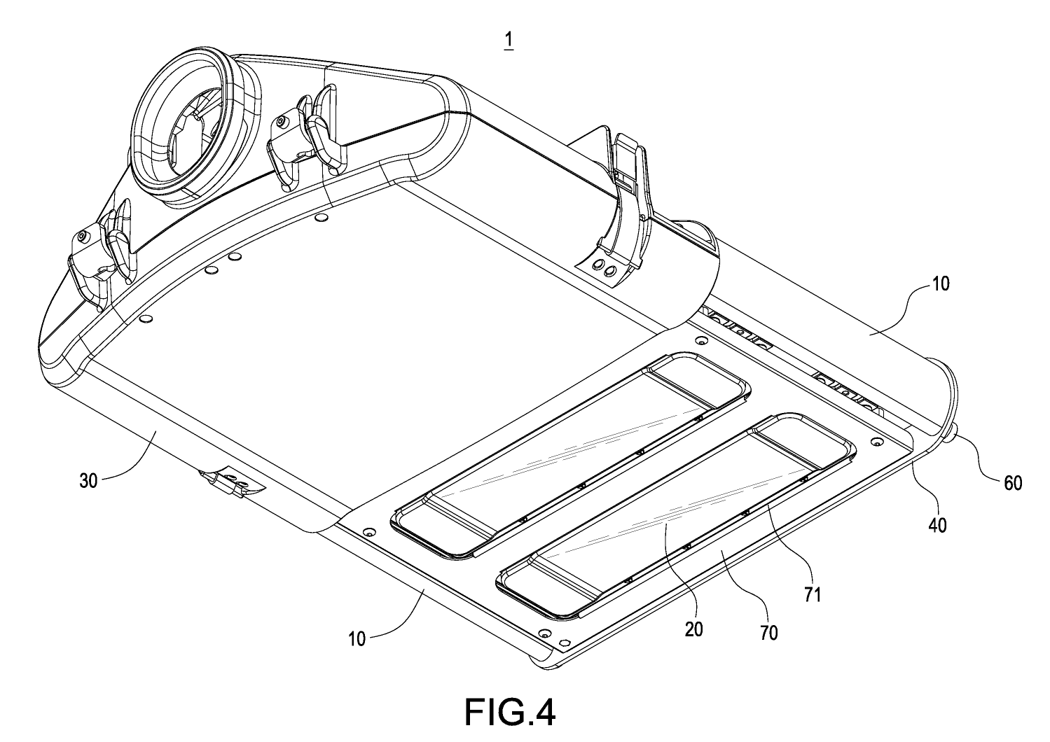

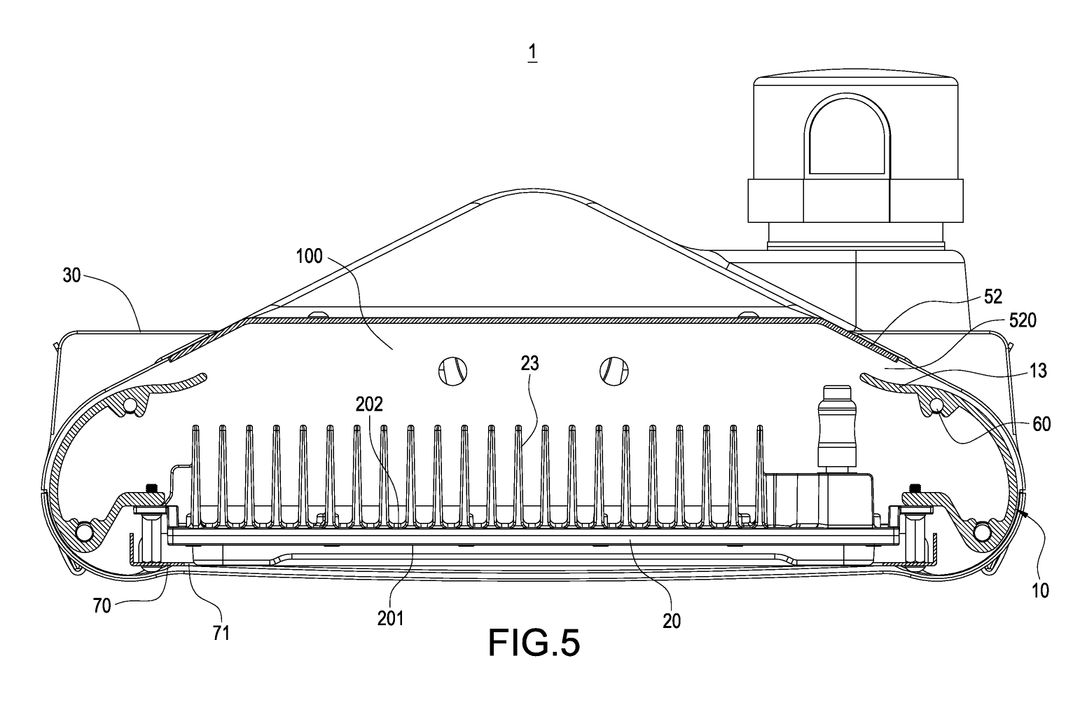

Please refer to the FIG. 4 and FIG. 5, they depict another perspective view of LED street lamp and an assembled cross sectional view of the present invention. When assembled, LED modules 20 are fixed between the pair of the frames 10, the side cover 40, the back cover 50 and the decoration plate 70 and configured as a set of LED light source. Then put the LED light source in a side of the electrical box 30. From the FIG. 5, when the back cover covers those LED modules 20, each side wing 52 extends to an outer of the blocking plate 13, and a gap 520 is held between the side wing 52 and the blocking plate 13.

When the LED street 1 of the present invention is in use, the heat resulted from those LED modules 20 will be conducted to the heat dissipating fins assembly 23 and then dissipated quickly to the accommodation 100 formed by the frames 10, side cover 40 and the back cover 50. Afterward, the heat will dissipate through the heat dissipating fins assembly 23 having large heat dissipating areas. At last, the heat will dissipate from the gap 520 formed between the side wing 52 and the blocking plate 13.

Because each side wing 52 is extended to an outer of the blocking plate 13, when it rains, the rain will drop along the side wing 52 and on the outer surface of the blocking plate 13. Then the rain will fall out the LED street lamp 1 along the blocking plate 13 and the cover plate 11.

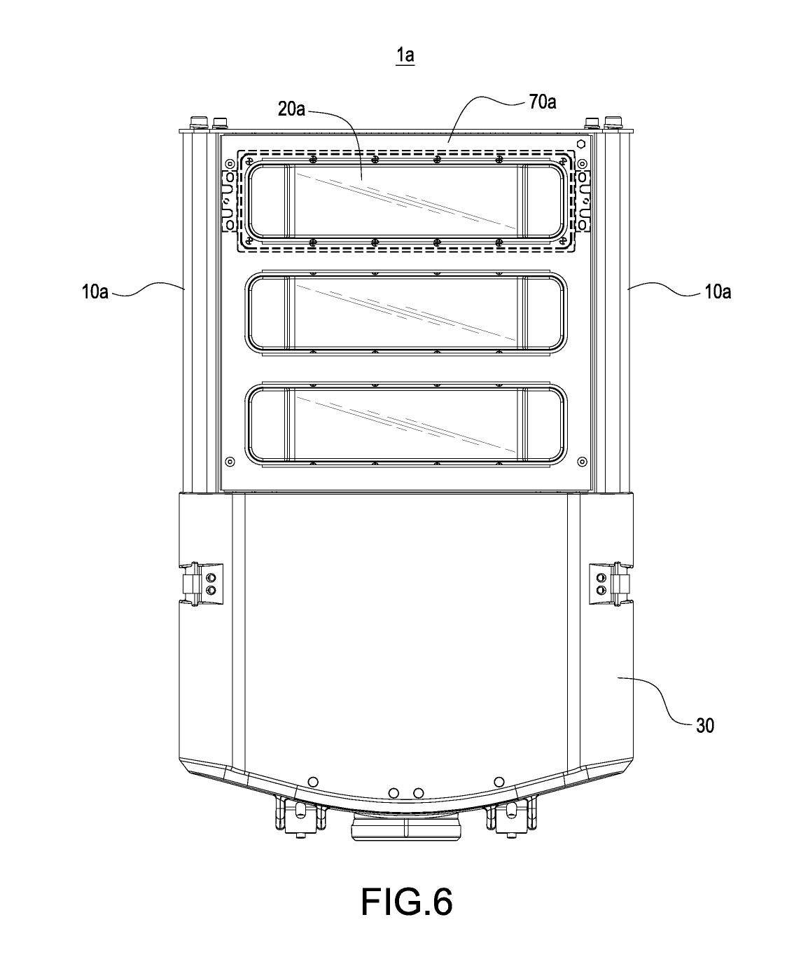

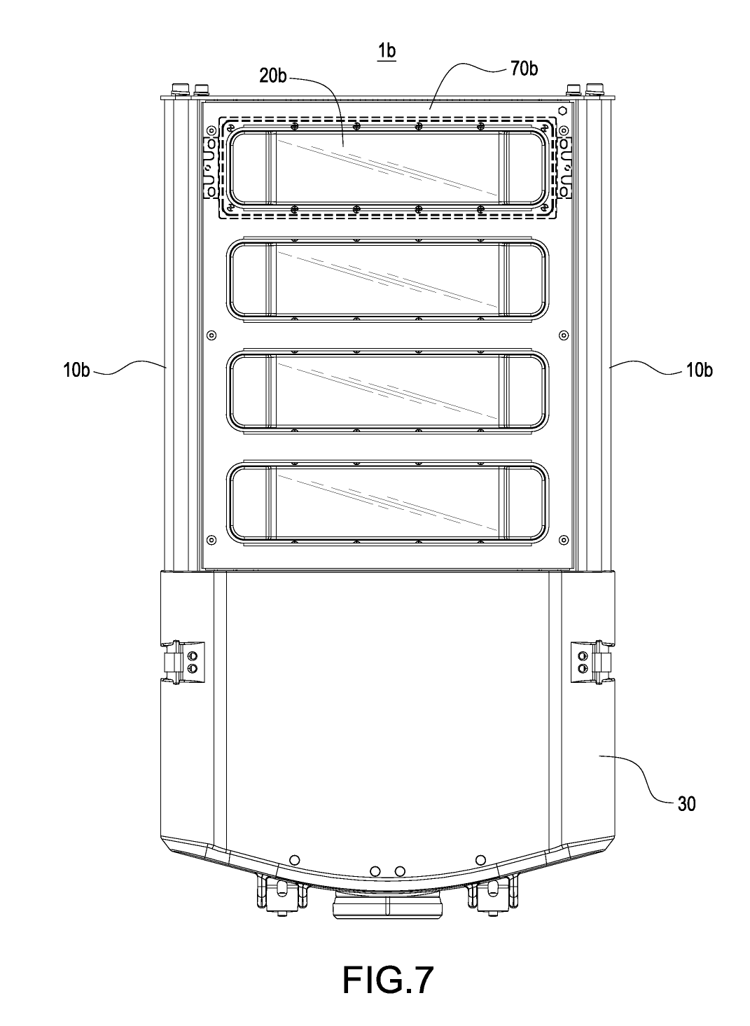

With refer to FIG. 6 and FIG. 7, they depict another two embodiments of the present invention. The two embodiments are substantially the same as the first embodiment. These two embodiments differ from the first embodiment in the quantity of the LED modules and the length of the frames to be provided. In FIG. 6, an LED street lamp la includes three LED modules 20a. In FIG. 7, an LED street lamp 1b includes four LED modules 20b.

In FIG. 6, the length of the frame 10a is lengthened as the length of three LED modules 20a is increased. Besides, a decoration plate 70a has a plurality of apertures 71a with a quantity corresponding to an amount of the LED modules 20a. It's worth noting that an electrical box 30a is similarly placed in a lateral side and electrically connected with those LED modules 20a.

In a same way, in FIG. 7, the length of the frame 10b is lengthened and adjusted by the length of four LED modules 20a. Besides, a decoration plate 70b is provided with four apertures 71b disposed at internal with a quantity corresponding to an amount of the LED modules 20b. Also an electrical box 30b is placed in a lateral side and electrically connected with those LED modules 20b.

Although the present invention has been described with reference to the preferred embodiment thereof, it will be understood that the invention is not limited to the details thereof Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. An LED street lamp, comprising:
a pair of frames disposed in symmetry, each of the frames having a cover plate, a supporting plate and a blocking plate, the supporting plates and the blocking plates located on opposite sides of the cover plate being bent and extended from sides of the cover plate respectively;
a plurality of LED modules arranged between the pair of the frames in parallel and at interval, two sides of each LED module fixed on the supporting plates of the frames correspondingly, each of the LED modules including a circuit board, plural LEDs disposed on the circuit board and a heat dissipating fins assembly, and the LED module having a back face without light emission and a light emitting face;
an electrical box disposed by a lateral side of the LED modules and covering one side of the frames;
a side cover covering another side of the frames; and
a back cover positioned between the pair of frames and covering on the back faces of the LED modules.

2. The LED street lamp according to claim 1, further comprising a plurality of fasten components, wherein the cover plate has a first combination hole at the location where the cover plate joins with the supporting plate and a second combination hole at the location where the cover plate joins with the blocking plate, the side cover has a first fixing hole and a second fixing hole corresponding to the first combination hole and the second combination hole, the fasten components pass through the first combination hole and the first fixing hole, the second combination hole and the second fixing hole respectively.

3. The LED street lamp according to claim 1, wherein the cover plate is a curved sheet, the supporting plate is bent from one side of the curved sheet and extended in a horizontal direction, and an opening is formed between the supporting plate and the blocking plate.

4. The LED street lamp according to claim 1, wherein the back cover covers a top of the heat dissipating fins assembly.

5. The LED street lamp according to claim 1, wherein the side cover has a plurality of heat dissipating holes.

6. The LED street lamp according to claim 1, wherein the back cover includes a bottom plate and a pair of side wings extending from opposite sides of the bottom plate, each side wing is extended to an outer of the blocking plate, and a gap is held between the side wing and the blocking plate.

7. The LED street lamp according to claim 6, wherein one side of the bottom plate is fixed on the bottom edge of the side cover, and another side of the bottom plate is fixed on the electrical box.

8. The LED street lamp according to claim 7, further comprising a decoration plate covering the light emitting faces of the LED modules.

9. The LED street lamp according to claim 8, wherein the decoration plate has a plurality of apertures with a quantity corresponding to an amount of the LED modules.

10. The LED street lamp according to claim 8, wherein each supporting plate has a plurality of screw bolts, the decoration plate screwed on the screw bolts.
